(19) United States
(12) Patent Application Publication
(10) Pub. No.: US 2011/0120823 A1
(43) Pub. Date: May 26, 2011

(54) Retracta Belt Brake System

(76) Inventors: Charles Hansen, West Babylon, NY (US); Bryan Torsiello, East Islip, NY (US)

(21) Appl. No.: 12/592,255

(22) Filed: Nov. 20, 2009

(51) Int. Cl. F16D 59/00; B65H 23/18; E01F 9/019

(52) U.S. Cl. 188/272; 242/412; 404/13

(57) ABSTRACT

A pedestrian traffic control stanchion including a post having an upper end and a lower end; a belt cassette assembly mounted on an upper end of the post; a spring case assembly positioned adjacent to and operatively connected to the belt cassette assembly to provide tension on a belt as the belt is extracted from the belt cassette assembly; a brake case assembly positioned adjacent to the belt cassette assembly and operatively connected to the belt cassette assembly to dampen the rate of rotation of the belt cassette assembly as the belt is retracted into the belt cassette assembly under the tension force exerted by the spring case assembly; the brake case assembly including a housing, a drive gear positioned within the housing, said drive gear being configured to be connected to the belt cassette assembly, a floating gear positioned within the housing in a position to engage the drive gear, the floating gear having an axial shaft extending therefrom, wherein the axial shaft of the floating gear is positioned within a slot formed in the housing, the slot having a first end and a second end; and a gear driven damper assembly positioned within the housing and configured to engage the floating gear when the axial shaft of the floating gear is positioned in one of the first end or the second end.

### BACKGROUND OF THE INVENTION

1. Field of the Invention

The present invention relates to pedestrian traffic control stanchion posts, and, more specifically, to a brake system used to control the retraction of a belt within the pedestrian traffic control stanchion post.

2. Description of the Background Art

This invention relates to pedestrian traffic control barriers of the type including a vertical post or stanchion, and a cassette mounted on the upper end of the post or stanchion, the cassette incorporating a flexible tape or belt wound on a spool, the tape or belt being extendable in a horizontal direction from the post. The tape or belt is extended by pulling on its free end, causing the tape to unwind from a spool within the cassette against the force of a retractor spring tending to rotate the spool so as to rewind the tape. The free end of the tape is attached to the upper end of another similar post, or in some cases to a fixed bracket on a wall, so as to establish the barrier for guiding pedestrian traffic.

Pedestrian traffic control stanchions are typically portable post assemblies and are commonly used by amusement parks, airports, maintenance personnel and other individuals to regulate pedestrian traffic. The stanchions are placed in a manner to indicate to pedestrians where the pedestrians should walk or queue. Pedestrian traffic control stanchions are commonly also used to cordon off certain areas to prevent the public from entering restricted areas.

Stanchions are generally not used singly. Flexible or rigid connecting members such as chains, ropes, tapes or rails are usually used to connect stanchion posts to each other, usually in a linear fashion, or to wall mounted rings. Some connecting members are independent. Independent connecting members can be removed from the stanchions. These independent connecting members have hooks or snaps at both ends to facilitate attaching the connecting members to stanchions.

Many stanchions, however, have extendible and retractable belts that are internally stored within a housing attached to, or part of, the stanchion. The belt is wound onto a reel that comprises part of the stanchion assemblies. These belts can be extended from the stanchion post by unwinding them from the reels. The virtue of a stanchion with an extendible internally stored belt is convenience. First, there is no need to store the connecting member separately. The belt is internal to the stanchion and stored with it. The belt cannot be lost. Second, an extendible belt can be used to delineate any distance up to the maximum extension of the belt. It is not necessary to stock multiple length connectors since the belt can be extended as far as desired up to the maximum extension.

The reels commonly have spring mechanisms to keep the belts taut when extended and to rewind the belts after use. Extending the belt causes the spring to be wound, storing potential energy in the spring. When it is desired to rewind the extended belt, the stored potential energy spins the reel rewinding the belt.

Although belt stanchion posts with internal belts are convenient, spring rewind mechanisms have limitations. Spring mechanisms can, and frequently do, break. Breakage renders the belt mechanism inoperable. Also, releasing a completely extended belt may cause it to rewind with excessive speed, thereby causing damage to the belt and related components or causing injury to personnel in proximity to the belt.

Attempts have been made in the prior art to regulate the speed of the belt as it retracts. One example of such a device is one which employs centrifugal pads. The pads expand radially in response to the centrifugal force as the belt retracts and slow the belt due to the friction with the wall. However, this type of brake mechanism has disadvantages. For example, the belt must travel a certain distance before the amount of centrifugal force necessary to cause the pads to expand radially is generated. Also, once engaged, the pads typically provide a fixed amount of braking force and it is difficult to control the level of the braking force.

Accordingly, there is a need in the art for an improved apparatus for effectively regulating the speed of the belt as it retracts.

### SUMMARY OF THE INVENTION

It is an object of the present invention to provide an apparatus for controlling the rate of retraction of a belt for use with pedestrian traffic control stanchions. Accordingly, a brake assembly for dampening the rate of rotation of a rotary member is provided, wherein the brake assembly includes a housing; a drive gear positioned within the housing, said drive gear being configured to be connected to the rotary member; a floating gear positioned within the housing in a position to engage the drive gear, the floating gear having an axial shaft extending from a surface thereof, wherein the axial shaft of the floating gear is positioned within a slot formed in the housing, the slot having a first end and a second end; and a gear driven damper assembly positioned within the housing and configured to engage the floating gear when the axial shaft of the floating gear is positioned in one of the first end or the second end.

It is also an object of the present invention to provide a pedestrian traffic control stanchion including a post having an upper end and a lower end; a belt cassette assembly mounted on an upper end of the post; a spring case assembly positioned adjacent to and operatively connected to the belt cassette assembly to provide tension on a belt as the belt is extracted from the belt cassette assembly; a brake case assembly positioned adjacent to the belt cassette assembly and operatively connected to the belt cassette assembly to dampen the rate of rotation of the belt cassette assembly as the belt is retracted into the belt cassette assembly under the tension force exerted by the spring case assembly; the brake case assembly including a housing, a drive gear positioned within the housing, said drive gear being configured to be connected to the belt cassette assembly, a floating gear positioned within the housing in a position to engage the drive gear, the floating gear having an axial shaft extending from a surface thereof, wherein the axial shaft of the floating gear is positioned within a slot formed in the housing, the slot having a first end and a second end; and a gear driven damper assembly positioned within the housing and configured to engage the floating gear when the axial shaft of the floating gear is positioned in one of the first end or the second end.

The invention is not limited to the above-described embodiments, and various changes are possible without departing from the principles set forth herein. Furthermore, the embodiments include the invention at various stages, and various inventions can be extracted by properly combining multiple disclosed constructional requirements. There are many applications of this design.

The above is a brief description of some deficiencies in the prior art and advantages of the present invention. Other features, advantages and embodiments of the invention will be apparent to those skilled in the art from the following description and drawings.

### BRIEF DESCRIPTION OF THE DRAWINGS

The invention will become more clearly understood from the following detailed description in connection with the accompanying drawings, in which:

FIG. 1 is a side view illustrating components of a belt cassette mounted on an upper end of a post or stanchion, in accordance with an embodiment of the present invention;

FIG. 2 is a side cross-section view of FIG. 3 illustrating a brake case, in accordance with an embodiment of the present invention;

FIG. 3 is a top view illustrating a brake case, in accordance with an embodiment of the present invention;

FIG. 4 is a top view illustrating a brake assembly, in accordance with an embodiment of the present invention;

FIG. 5 is a cross-section view along arrows A-A of FIG. 4 illustrating a brake assembly, in accordance with an embodiment of the present invention;

FIG. 6 is a side view illustrating a brake drive gear, in accordance with an embodiment of the present invention;

FIG. 7 is a top view illustrating a brake drive gear, in accordance with an embodiment of the present invention;

FIG. 8 is a side view illustrating a floating gear, in accordance with an embodiment of the present invention;

FIG. 9 is a top view illustrating a floating gear, in accordance with an embodiment of the present invention;

FIG. 10 is a side cross-section view along arrows B-B of FIG. 11 illustrating a rotary brake assembly with a floating gear, in accordance with an embodiment of the present invention;

FIG. 11 is a top view illustrating a rotary brake assembly with a floating gear, in accordance with an embodiment of the present invention;

FIG. 12 is a side view illustrating a rotary brake assembly with a floating gear, in accordance with an embodiment of the present invention; and

FIG. 13 is a side cross-section view along arrows C-C of FIG. 12 illustrating a rotary brake assembly with a floating gear, in accordance with an embodiment of the present invention.

### DETAILED DESCRIPTION OF THE PREFERRED EMBODIMENTS

The following description is presented to enable one of ordinary skill in the art to make and use the invention and is provided in the context of a patent application and its requirements. Various modifications to the preferred embodiments will be readily apparent to those skilled in the art and the generic principles herein may be applied to other embodiments. Thus, the present invention is not intended to be limited to the embodiment shown but is to be accorded the widest scope consistent with the principles and features described herein.

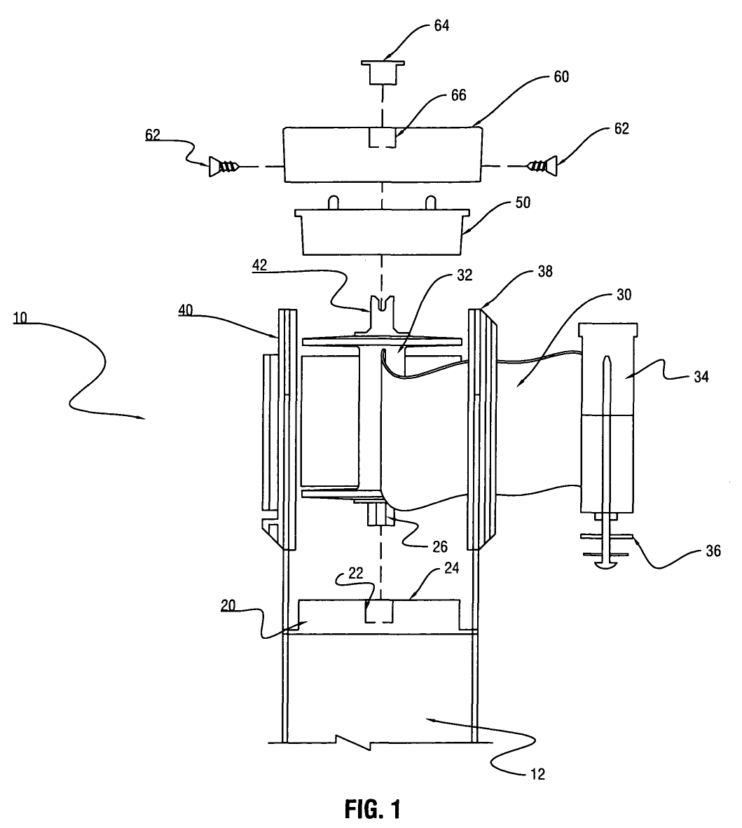

Referring now to the drawings in detail, and initially to FIG. 1, components of a belt cassette assembly 10 mounted on an upper end of a post or stanchion 12, in accordance with an embodiment of the present invention, is illustrated. Brake case assembly 20 is positioned at a lower end of belt cassette assembly 10. Although the brake case is illustrated at the lower end of the belt cassette assembly, it is contemplated that the brake case may be positioned at various locations within the cassette assembly. A hole 22 is defined in an upper surface 24 of brake case assembly 20 and is configured to receive a nipple 26 extending from a lower end of belt spool 32. Belt 30 is wound around belt spool 32 when in a retracted position. Belt 30 is extracted and retracted from the belt cassette assembly 10 through a belt guide 38. A belt end piece 34 is attached to a first end of belt 30. The belt end piece 34 prevents the belt 30 from completely retracting into the belt cassette 10. Belt end piece 34 is also preferably configured to attach to the upper end of another similar post, or in some cases to a fixed bracket on a wall, so as to establish the barrier for guiding pedestrian traffic. It is also contemplated that the present invention is not limited to the configuration of the belt end illustrated and described. Other belt end pieces known to one having ordinary skill in the art may be utilized. For example, belt ends are available that do not connect to a post or bracket, such as, magnetic belt ends, hook belt ends or S-hook belt ends which are configured to wrap around an object and attach back to the belt itself. The belt cassette 10 also includes one or more belt clips 40 for receiving belt end pieces from adjacent stanchions.

A nipple 42 extends from an upper end of belt spool 32 and is configured to fit within a hole formed in a lower surface of a spring case assembly 50. Nipple 42 preferably is configured with a forked end to engage components within the spring case assembly 50 to provide tension on the belt 30 as it is extracted from belt cassette 10.

A post cap 60 is mounted on an upper surface of the spring case assembly 50. The post cap 60 may be secured in place via one or more cap screws 62. Post cap 60 may be manufactured of a plastic or metal material. A hole 66 is preferably formed in the upper surface of post cap 60. Hole 66 is configured to receive sign frames and may also include a threaded inner surface. A plug 64 is provided to fit within hole 66 when a sign frame is not utilized.

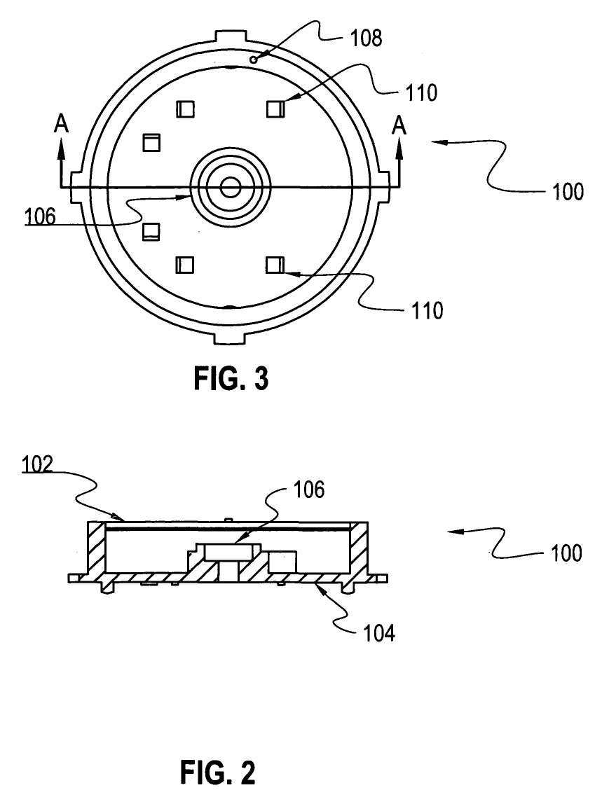

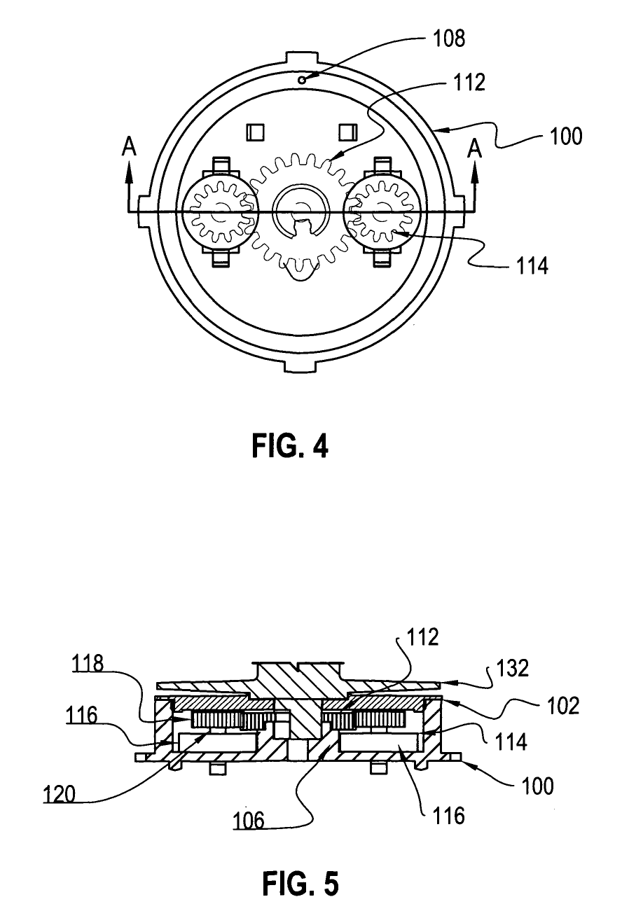

FIGS. 2 and 3 are a side cross-section view and a top view, respectively, illustrating a brake case 100 in accordance with an embodiment of the present invention. The brake case 100 includes an upper cover member 102 and a lower housing member 104. A raised ledge section 106 is formed in a central portion of the lower housing member, the significance of which will be described more fully with reference to FIGS. 4 and 5. At least one alignment pin 108 may be included to match a corresponding hole in cover member 102. One or more holes 110 are formed in the lower housing member 104 and are configured to receive components which are housed within the brake case 100. Preferably, brake case 100 is manufactured of a black plastic, but may be manufactured utilizing other materials and/or other colors (or translucent), each of which are known to one having ordinary skill in the art.

FIG. 4 is a top view illustrating a rotary brake assembly, in accordance with an embodiment of the present invention, and FIG. 5 is a cross-section view along arrows A-A of FIG. 4 illustrating the brake assembly. FIGS. 4 and 5 illustrate components of the brake case assembly situated within brake case 100. Additionally, for clarity, the top view illustrated in FIG. 4 is illustrated unencumbered by a cover or spool.

A drive gear 112 is coupled to a spool 132 (shown in FIG. 5) via a keyway extending axially along a nipple extending from the lower surface of spool 132. Therefore, as a belt is extracted and retracted, spool 132 is caused to rotate in a clockwise and counterclockwise direction, and drive gear 112 is caused to rotate in a clockwise and counterclockwise direction.

It is also contemplated that the damper mechanism is engaged in a manner other than a central drive gear as described and illustrated herein. For example, the case may be configured with gear teeth along the inside wall and may engage a damper which is offset to the side of the spool. Other gear configurations known to one having ordinary skill in the art are also contemplated. Also, the top of the damper may also be configured to fit into another opening. For example, the top of the damper may be square and configured to engage a square opening.

In the embodiment illustrated in FIGS. 4 and 5, two damper/gear assemblies 114 are shown. It is contemplated that the brake assembly may include one or more damper/gear assemblies. The damper/gear assemblies 114 include a lower damper member 116 and an upper gear member 118 coupled together by shaft 120. The damper members 116 are disposed within the void created by, and adjacent to, raised ledge section 106. The gear members 118 are positioned along the same plane, and adjacent to, drive gear 112 so that the teeth of drive gear 112 mesh with the teeth of gear members 118 as drive gear 112 is rotated in response to the rotation of spool 132.

Damper members 116 are preferably filled with a viscous liquid which causes resistance to be transferred through shaft 120 to gear 118 to gear 112 to spool 132 and, ultimately, to a belt that is being extracted or retracted to and from the spool 132. The end result of the damper is to slow down and/or control the rate of extraction and retraction of a belt. It is contemplated that the rate of extraction and retraction may be further controlled by changing the number of dampers, the size of the dampers and the viscosity of the fluid within the dampers.

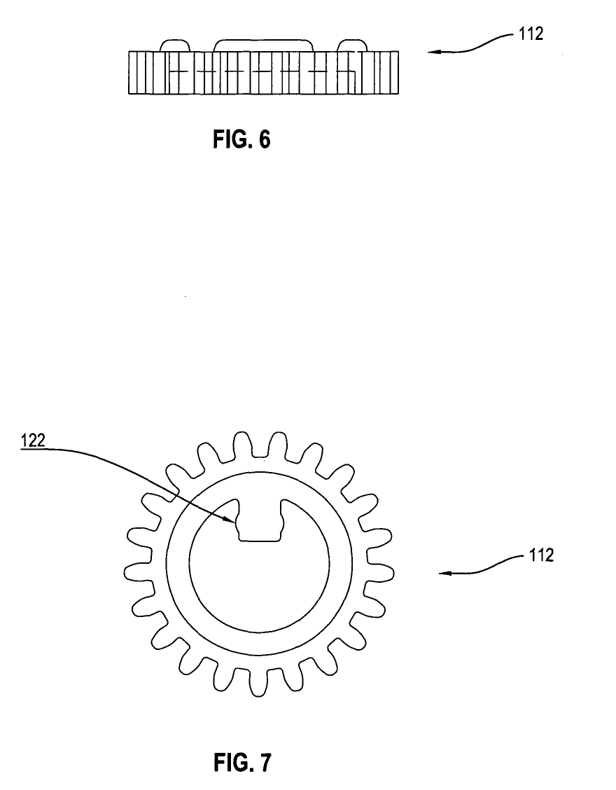

FIGS. 6 and 7 provide further detailed views of a drive gear 112 in accordance with an embodiment of the present invention. The diameter of the drive gear and the gear teeth detail may be modified in accordance with a particular design requirement. Preferably, the drive gear 112 includes a keyway 122 formed on an inner diameter. The keyway 122 is dimensioned to engage an axial slot in a spool. Other means for connecting the drive gear and spool are also contemplated such as, for example, molding the gear to the spool.

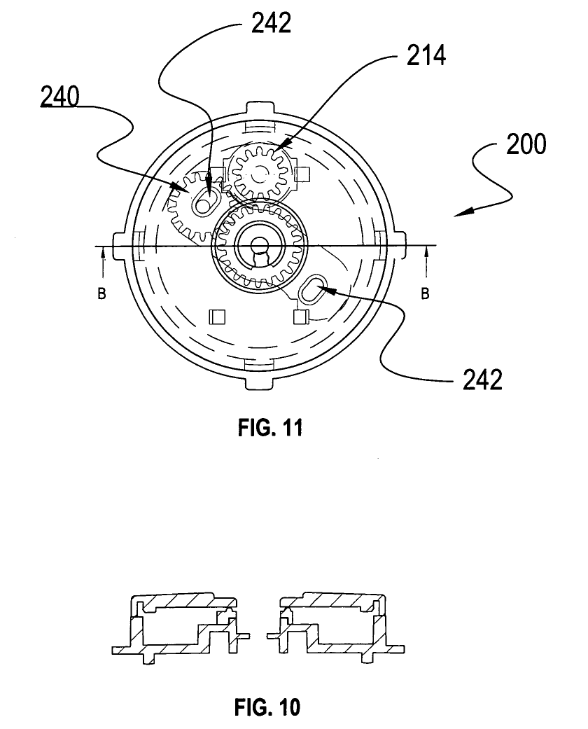

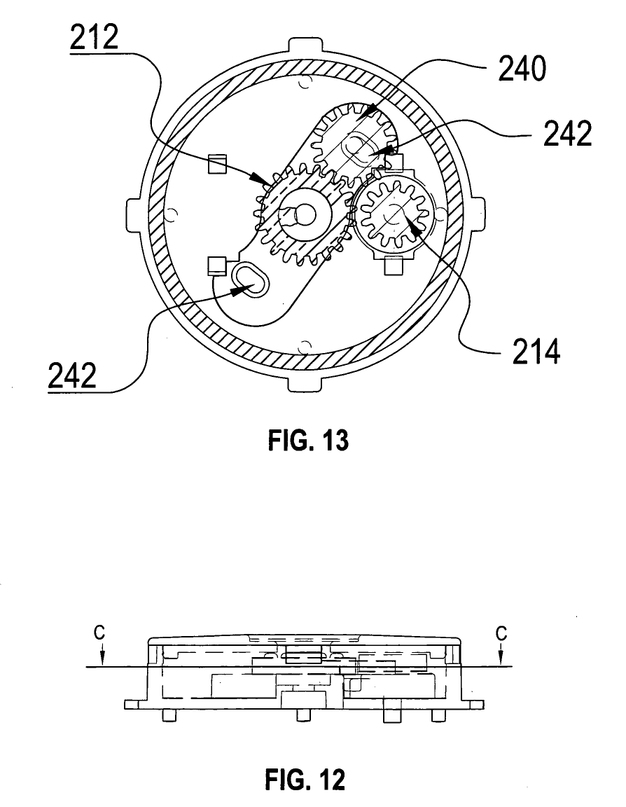

Referring now to FIGS. 10 through 12 wherein another embodiment of a rotary brake assembly with a floating gear in accordance with the present invention is illustrated. FIG. 10 is a side cross-section view along arrows B-B of FIG. 11 illustrating a rotary brake assembly. FIG. 11 is a top illustrating a rotary brake assembly, in accordance with an embodiment of the present invention. FIG. 12 is a side view illustrating a rotary brake assembly, in accordance with an embodiment of the present invention, and FIG. 13 is a side cross-section view along arrows C-C of FIG. 12.

There is often not a need to control the extraction of the belt from the cassette, since the extraction is controlled by the hand of the user. That is, it is common for the user to hold the end of the belt during the extraction. More often, it is the rate of the retraction of the belt that must be controlled to prevent damage to the equipment and to prevent injury to personnel standing nearby. Moreover, the equipment is more susceptible to failure when a rotary brake is in use during both the extraction and retraction stages.

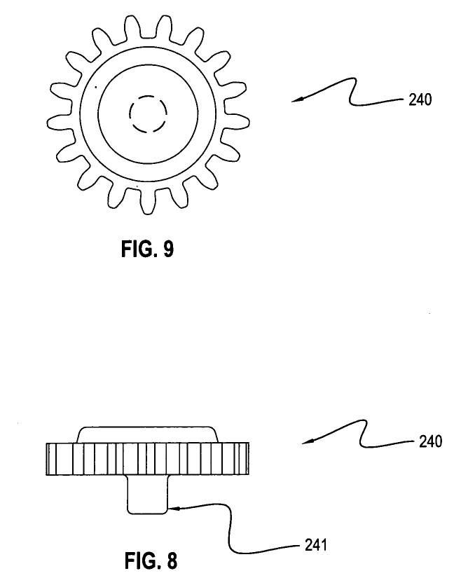

The embodiment of the present invention illustrated in FIGS. 10 through 13 provides a solution to these issues. In this embodiment, a floating gear 240 (illustrated in further detail in FIGS. 8 and 9) is added between the drive gear 212 and the damper gear 214 which allows the rotary brake assembly to disengage while the belt is being extracted. A shaft 241 (see FIG. 8) of the floating gear 240 is configured to move within a slot 242 formed in the brake housing 200. The drive gear 212 engages the floating gear 240 and the floating gear 240 selectively engages the teeth of the damper gear 214. More specifically, as the drive gear 212 turns in a first direction during extraction of the belt, the drive gear 212 engages the floating gear 240 and the force imparted by the drive gear 212 on the floating gear 240 causes the floating gear 240 to move within the slot 242 to a position wherein the floating gear 240 is not engaging the damper gear 214. However, during retraction of the belt, the drive gear 212 will rotate in the opposite direction thereby causing the floating gear 240 to shift to the end of the slot 242 closer to the damper gear 212 and consequently the teeth of the floating gear 240 will engage the teeth of the damper gear 214. A small amount of grease (or other dampening material) may be added to floating gear 240 if it is determined that the gear spins too freely.

Although the present invention has been described in accordance with the embodiments shown, one of ordinary skill in the art will readily recognize that there could be variations to the embodiment and these variations would be within the spirit and scope of the present invention. For example, the size of the damper, as well as the viscosity of the fluid utilized within the damper may affect the rate of extraction and/or retraction of the belt. Furthermore, it is contemplated that the present invention may be manufactured of various materials and in different sizes. Accordingly, many modifications may be made by one of ordinary skill in the art without departing from the spirit and scope of the invention.

What is claimed is:

1. A pedestrian traffic control stanchion comprising:
a post having an upper end and a lower end;
an elongate belt contained within said post;
said elongate belt being extendable from the post in a direction generally perpendicular to a longitudinal axis of the post;
means for maintaining tension on the belt while the belt is in an extended position such that the belt will retract into the post when a free end of the belt is not held; and
a damper assembly to dampen the rate of retraction of said belt.

2. A pedestrian traffic control stanchion as recited in claim 1 further comprising:
a base attached to a lower end of said post.

3. A pedestrian traffic control stanchion as recited in claim 1 further comprising:
a spool located within the post, wherein the belt is wound on the spool.

4. A pedestrian traffic control stanchion as recited in claim 1 wherein a slot is formed in the post in a position such that the elongate belt extends and retracts through said slot.

5. A pedestrian traffic control stanchion as recited in claim 1 wherein the means for maintaining tension on the belt while the belt is in an extended position is a spring assembly.

6. A pedestrian traffic control stanchion as recited in claim 1 wherein the damper assembly is operatively connected to a spool around which the belt is wound.

7. A pedestrian traffic control stanchion as recited in claim 1 wherein the damper assembly comprises a container having a viscous fluid therein.

8. A pedestrian traffic control stanchion as recited in claim 1 wherein the damper assembly is operatively connected to a spool around which the belt is wound via a gear.

9. A pedestrian traffic control stanchion as recited in claim 1 further comprising:
a spool located within the post, wherein the belt is wound on the spool; and
a drive gear connected to the spool such that rotation of the spool causes rotation of the drive gear; wherein the damper assembly is operatively connected to the drive gear to dampen the rate of rotation of the drive gear as the belt is wound on the spool.

10. A pedestrian traffic control stanchion as recited in claim 9 further comprising:
a floating gear configured to engage the drive gear, the floating gear being further configured to shift between a first position and a second position in response to the direction of the centrifugal force of the exerted by the drive gear; and
a gear driven damper assembly configured to be engaged by the floating gear when the floating gear is positioned in one of the first and second positions.

11. A pedestrian traffic control stanchion as recited in claim 10 wherein the gear driven damper assembly is engaged by the floating gear when the drive gear is rotating in a direction to cause the elongate belt to be retracted from an extended position back into the post.

12. A brake assembly for dampening the rate of rotation of a rotary member, the brake assembly comprising:
a housing;
a drive gear positioned within the housing, said drive gear being configured to be connected to the rotary member;
a floating gear positioned within the housing in a position to engage the drive gear, the floating gear having an axial shaft extending therefrom, wherein the axial shaft of the floating gear is positioned within a slot formed in the housing, the slot having a first end and a second end; and
a gear driven damper assembly positioned within the housing and configured to engage the floating gear when the axial shaft of the floating gear is positioned in one of the first end or the second end.

13. The brake assembly for dampening the rate of rotation of a rotary member, as recited in claim 12 wherein rotation of the drive gear in a first rotational direction causes the floating gear to shift to a first end of the slot and rotation of the drive gear in a second rotational direction causes the floating gear to shift to a second end of the slot.

14. A pedestrian traffic control stanchion comprising:
a post having an upper end and a lower end;
a belt cassette assembly mounted on an upper end of the post;
a spring case assembly positioned adjacent to and operatively connected to the belt cassette assembly to provide tension on a belt as the belt is extracted from the belt cassette assembly;
a brake case assembly positioned adjacent to the belt cassette assembly and operatively connected to the belt cassette assembly to dampen the rate of rotation of the belt cassette assembly as the belt is retracted into the belt cassette assembly under the tension force exerted by the spring case assembly; the brake case assembly comprising a housing, a drive gear positioned within the housing, said drive gear being configured to be connected to the belt cassette assembly, a floating gear positioned within the housing in a position to engage the drive gear, the floating gear having an axial shaft extending therefrom, wherein the axial shaft of the floating gear is positioned within a slot formed in the housing, the slot having a first end and a second end; and a gear driven damper assembly positioned within the housing and configured to engage the floating gear when the axial shaft of the floating gear is positioned in one of the first end or the second end.
